(19) United States
(12) Patent Application Publication
(10) Pub. No.: US 2016/0358534 A1
(43) Pub. Date: Dec. 8, 2016

(54) DISPLAY PANEL AND DISPLAY DEVICE

(71) Applicant: BOE TECHNOLOGY GROUP CO., LTD., Beijing (CN)

(72) Inventor: Heecheol Kim, Beijing (CN)

(21) Appl. No.: 14/892,601

(22) PCT Filed: Apr. 16, 2015
(86) PCT No.: PCT/CN2015/076749

§ 371 Date: Nov. 20, 2015

(30) Foreign Application Priority Data
Dec. 30, 2014 (CN) 201410851858.9

(51) Int. Cl. G09G 3/20; G06F 3/14

(52) U.S. Cl. CPC G09G 3/2092; G06F 3/1423; G09G 2310/0202

(57) ABSTRACT

The present disclosure relates to a display panel and a display device. A source driving unit and a gate driving unit in the display panel are arranged in a peripheral area on two opposite sides of a display area respectively, namely when the source driving unit and the gate driving unit are longitudinally arranged in the peripheral area at the upper end and the lower end of the display area respectively, narrow-bezel design on the left side and the right side of the display panel can be achieved, and when the source driving unit and the gate driving unit are transversely arranged in the peripheral area at the left end and the right end of the display area respectively, narrow-bezel design on the upper side and the lower side of the display panel can be achieved. Therefore, compared with the mode that a plurality of display panels are connected to achieve multi-screen display in the prior art, the narrow-bezel design on the left side and the right side of or the upper side and the lower side of the display panel provided by embodiments of the present disclosure can be achieved, so that when transverse or longitudinal multi-screen display is achieved, a non-image-display area at the connecting position of adjacent display panels is relatively small, thereby the visual effect of a display image is effectively improved.

### FIELD

The present disclosure relates to the technical field of display, in particular to a display panel and a display device.

### BACKGROUND

Currently, the display technology is widely applied to televisions, mobile phones and the display of public information, and flat panel displays for displaying images are widely popularized due to the ultra-thin and energy-saving advantages thereof. In display products such as digital display screens or digital label display screens applied to advertisement information display, in order to achieve large-screen display, a plurality of display panels are usually connected and adhered to achieve multi-screen display.

In a traditional display panel structure, as shown in FIG. 1a, source driving units are arranged at one end of the peripheral area of the display panel, for example, as shown in FIG. 1a, the source driving units arranged at the upper end of the display panel are used for inputting data signals to the display area of the display panel, and gate driving units are arranged at the other end of the peripheral area of the display panel, for example, as shown in FIG. 1a, the gate driving unit arranged at the left end of the display panel are used for inputting gate scanning signals to the display area of the display panel, so that data lines and gate lines are distributed in a right-angled manner with each other, namely the source driving units and the gate driving units are distributed in the peripheral area of the display panel and are arranged in the horizontal direction and the vertical direction which are vertical to each other respectively. In such distribution mode when a plurality of display panels are connected in a left-and-right connection manner to achieve multi-screen display, since the gate driving units occupy the peripheral area on the left side of the display panel, the area of the frame part is relatively wide, so that the non-image-display area at the connecting position of adjacent display panels is relatively large. When the multi-screen display is achieved, as shown in FIG. 1b, wherein the non-image-display area a of the display image at the connecting position of two adjacent display panels is relatively large, leading to the problem that the visual effect of the display image is relatively poor.

Therefore, there is an urgent need for those skilled in the art to solve the technical problem of how to reduce the non-display-image area at the connecting position of adjacent display panels during multi-screen display so as to improve the visual effect of the display image during multi-screen display.

### SUMMARY

Embodiments of the present disclosure provide a display panel and a display device, which are used for solving at least some of problems existing in the prior art.

An embodiment of the present disclosure provides a display panel, comprising a display area and a peripheral area surrounding the display area, wherein the display panel in the display area may comprise a plurality of gate lines extending along a first direction and a plurality of data lines extending along a second direction; the display panel in the peripheral area may comprise a source driving unit for supplying data signals for each data line and a gate driving unit for supplying gate scanning signals for each gate line; the source driving unit and the gate driving unit are arranged in the peripheral area on two opposite sides of the display area respectively.

In one possible implementation, in the display panel provided by an embodiment of the present disclosure, the gate driving unit may be positioned in the peripheral area that either end of the data lines pointing to; or, the source driving unit may be positioned in the peripheral area that either end of the gate lines pointing to.

In one possible implementation, in the display panel provided by an embodiment of the present disclosure, when the gate driving unit is positioned in the peripheral area that either end of the data lines pointing to, the display panel in the display area may further comprise first wires in the directions the same as the extending directions of the data lines and in one-to-one correspondence with the gate lines, and the first guide lines are used for connecting the corresponding gate lines to the gate driving unit.

In one possible enforcement mode, in the display panel provided by the embodiment of the present disclosure, the first guide lines and the data lines can be arranged in the same layer and are isolated from each other; or, the first guide lines can be positioned in a third metal layer, and the metal layer is a metal layer except the layers where the data lines and the gate lines are located.

In one possible implementation, in the display panel provided by an embodiment of the present disclosure, when the source driving unit is positioned in the peripheral area that either end of the gate lines pointing to, the display panel in the display area may further comprise second wires in the directions the same as the extending directions of the gate lines and in one-to-one correspondence with the data lines, the second wires connecting the corresponding data lines to the source driving unit.

In one possible implementation, in the display panel provided by an embodiment of the present disclosure, the second wires and the gate lines may be arranged in the same layer and isolated from each other; or, the second wires may be positioned in a third metal layer, and the third metal layer is a metal layer except the layers where the data lines and the gate lines are positioned.

In one possible implementation, in the display panel provided by an embodiment of the present disclosure, the gate driving unit may be a gate drive chip or a gate integrated drive circuit.

In one possible implementation, in the display panel provided by an embodiment of the present disclosure, when the gate driving unit is the gate integrated drive circuit, the gate integrated drive circuit may be provided with various signal input ends, and the source driving unit may further be provided with various signal output ends; and the display panel in the display area may further comprise a plurality of third wires, which connect the various signal output ends of the source driving unit with the various signal input ends of the gate integrated drive circuit in one-to-one correspondence manner.

In one possible implementation, in the display panel provided by an embodiment of the present disclosure, the gate integrated drive circuit is positioned in the peripheral area that either end of the data lines pointing to, and the third wires and the data lines may be arranged in the same layer and isolated from each other, or the third wires may be positioned in a third metal layer, and the third metal layer is a metal layer except the layers where the data lines and the gate lines are positioned; or,

the gate integrated drive circuit is positioned in the peripheral area that either end of the gate lines pointing to, and the third wires and the gate lines may be arranged in the same layer and isolated from each other, or the third wires are positioned in a third metal layer, the third metal layer is a metal layer except the layers where the data lines and the gate lines are positioned.

An embodiment of the present disclosure provides a display device, comprising the display panel provided by above embodiments of the present disclosure.

The beneficial effects of embodiments of the present disclosure are as follows.

Embodiments of the present disclosure provide a display panel and a display device. In the display panel, the source driving unit and the gate driving unit are arranged in the peripheral area on two opposite sides of the display area respectively, namely when the source driving unit and the gate driving unit are longitudinally arranged in the peripheral area at the upper end and the lower end of the display area respectively, since the source driving unit and the gate driving unit are not arranged at the left end and the right end of the peripheral area of the display panel, narrow-bezel design on the left side and the right side of the display panel can be achieved, so that when a plurality of display panels are transversely connected to achieve multi-screen display, a non-image-display area at the connecting position of adjacent display panels becomes relatively small. Likewise, when the source driving unit and the gate driving unit are transversely arranged in the peripheral area at the left end and the right end of the display area respectively, since the source driving unit and the gate driving unit are not arranged at the upper end and the lower end of the peripheral area of the display panel, narrow-bezel design on the upper side and the lower side of the display panel can be achieved, so that when a plurality of display panels are longitudinally connected to achieve multi-screen display, the non-image-display area at the connecting position of adjacent display panels becomes relatively small. Therefore, compared with the mode that a plurality of display panels are connected to achieve multi-screen display in the prior art, the narrow-bezel design on the left side and the right side of or the upper side and the lower side of the display panel provided by the embodiments of the present disclosure can be achieved, so that when transverse or longitudinal multi-screen display is achieved, the non-image-display area at the connecting position of adjacent display panels is relatively small, thereby the visual effect of a display image is effectively improved.

### BRIEF DESCRIPTION OF DRAWINGS

FIG. 1a is a schematic diagram of the structure of a display panel in the prior art;

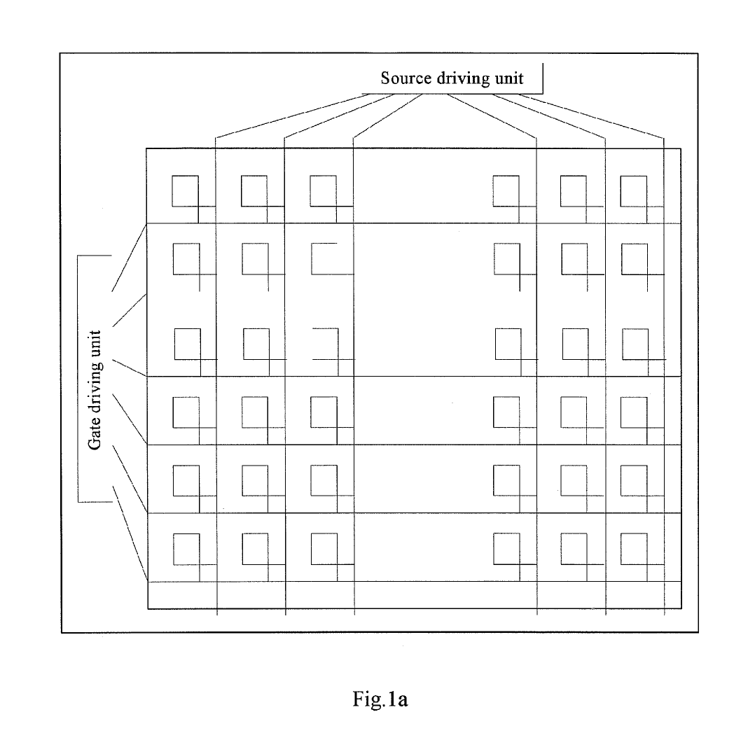

FIG. 1b is a schematic diagram of a multi-screen display image in the prior art;

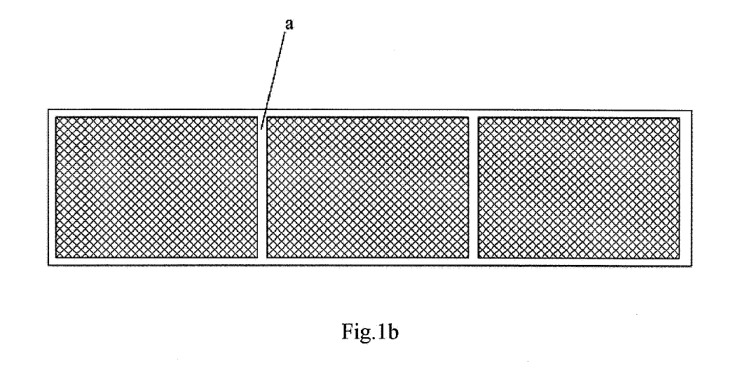

FIG. 2a is a schematic diagram of the structure of a display panel provided by an embodiment of the present disclosure;

FIG. 2b is a schematic diagram of the structure of a display panel provided by another embodiment of the present disclosure;

FIG. 2c is a specific connection of first wires in a pixel structure provided by an embodiment of the present disclosure;

FIG. 3a is a schematic diagram of the structure of a display panel provided by an embodiment of the present disclosure;

FIG. 3b is a schematic diagram of the structure of a display panel provided by another embodiment of the present disclosure.

### DETAILED DESCRIPTION

The detailed description of the specific implementations of a display panel and a display device provided by embodiments of the present disclosure is further described in conjunction with the accompanying diagrams.

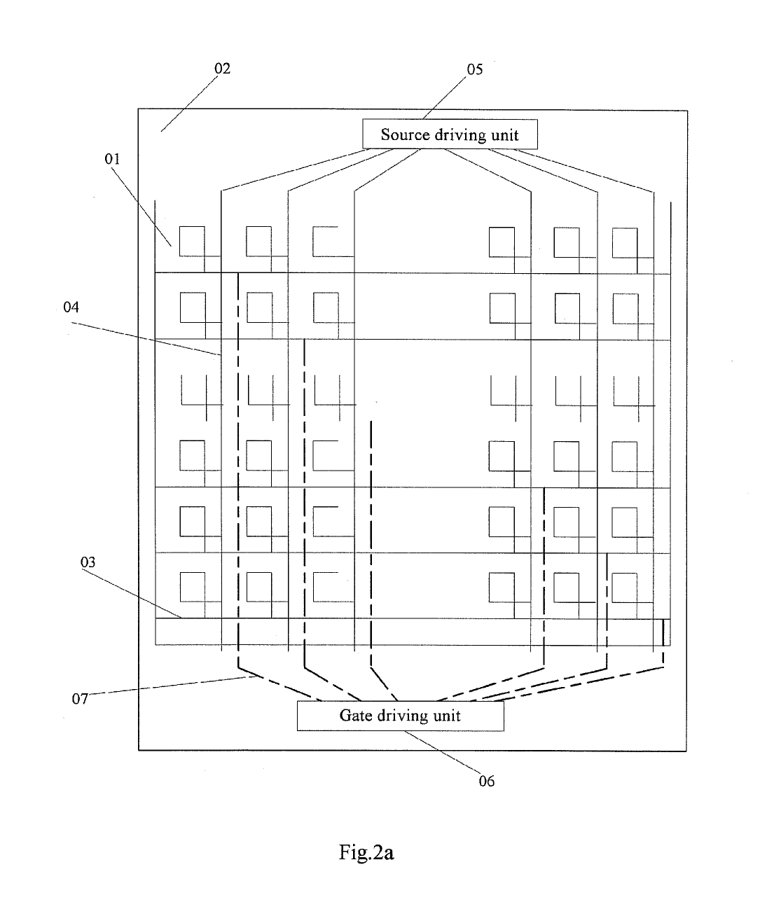

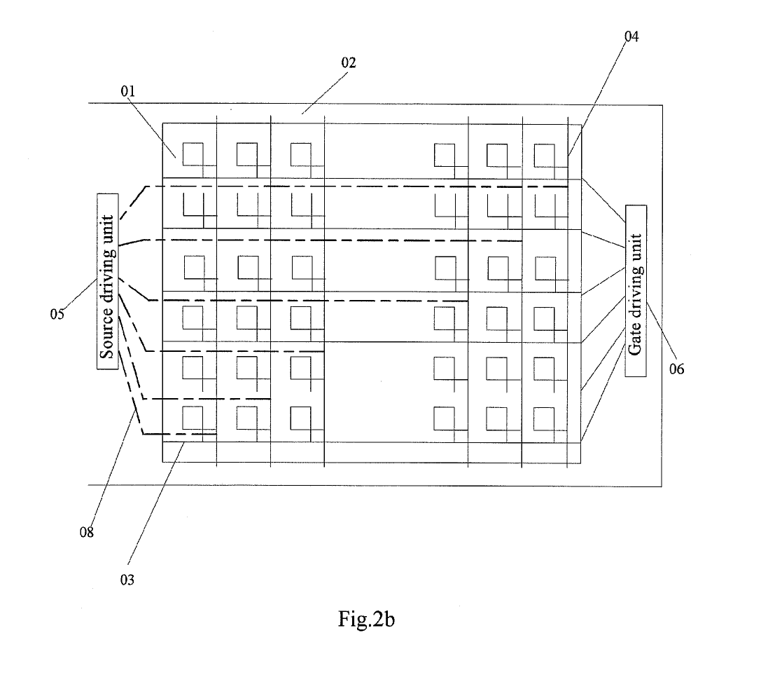

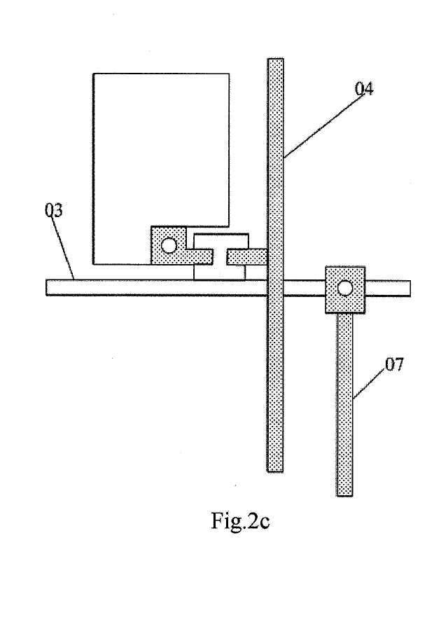

A display panel, as shown in FIG. 2a and FIG. 2b, comprises a display area 01 and a peripheral area 02 surrounding the display area 01; the display panel in the display area 01 comprises a plurality of gate lines 03 extending along a first direction and a plurality of data lines 04 extending along a second direction; the display panel in the peripheral area 02 comprises a source driving unit 05 for supplying data signals for each data line 04 and a gate driving unit 06 for supplying gate scanning signals for each gate line 03.

The source driving unit 05 and the gate driving unit 06 are arranged in the peripheral area 02 on two opposite sides of the display area 01 respectively.

In above display panel, the source driving unit 05 and the gate driving unit 06 are arranged in the peripheral area 02 on two opposite sides of the display area 01 respectively in the display panel, namely as shown in FIG. 2a, when the source driving unit 05 and the gate driving unit 06 are arranged in the peripheral area 02 at the upper end and the lower end of the display area 01 respectively, since the source driving unit 05 and the gate driving unit 06 are not arranged at the left end and the right end of the peripheral area 02 of the display panel, narrow-bezel design on the left side and the right side of the display panel can be achieved, so that when a plurality of display panels are transversely connected to achieve multi-screen display, a non-image-display area at the connecting position of adjacent display panels becomes relatively small. Likewise, as shown in FIG. 2b, when the source driving unit 05 and the gate driving unit 06 are arranged in the peripheral area 02 at the left end and the right end of the display area 01 respectively, since the source driving unit 05 and the gate driving unit 06 are not arranged at the upper end and the lower end of the peripheral area 02 of the display panel, narrow-bezel design on the upper side and the lower side of the display panel can be achieved, so that when a plurality of display panels are longitudinally connected to achieve multi-screen display, the non-image-display area at the connecting position of adjacent display panels becomes relatively small. Therefore, compared with the mode that a plurality of display panels are connected to achieve multi-screen display in the prior art, the narrow-bezel design on the left side and the right side of or the upper side and the lower side of the display panel provided by the embodiment of the present disclosure can be achieved, so that when transverse or longitudinal multi-screen display is achieved, the non-image-display area at the connecting position of adjacent display panels is relatively small, thereby the visual effect of a display image is effectively improved.

the gate driving unit 06 may be positioned in the peripheral area 02 that either end of the data lines 04 pointing to, for example, as shown in FIG. 2a, the gate driving unit 06 is positioned in the peripheral area 02 at the lower end of the display area 01; and the gate driving unit 06 can also be arranged in the peripheral area 02 at the upper end of the display area 01, which is unlimited herein. In such cases, as shown in FIG. 2a, the display area 01 may further comprise first wires 07 in the directions the same as the extending directions of the data lines 04 and in one-to-one correspondence with the gate lines 03, the first wires 07 connecting the corresponding gate lines 03 to the gate driving unit 06.

Specifically, the gate driving unit 06 arranged as shown in FIG. 2a and the source driving unit 05 are arranged in the peripheral area 02 at the upper end and the lower end of the display area 01 respectively, wherein the source driving unit 05 inputs the data signals to the data lines 04 in the display area 01, and the gate driving unit 06 inputs the gate scanning signals to the gate lines 03 in the display area 01 via the first wires 07, and thus the display panel is controlled to achieve normal image display. Meanwhile, since the gate driving unit 06 and the source driving unit 05 are arranged in the peripheral area 02 at the upper end and the lower end of the display area 01 respectively, the narrow-bezel design on the left side and the right side of the display panel can be achieved, so that when a plurality of display panels are transversely connected to achieve multi-screen display, the non-image-display area at the connecting position of adjacent display panels is relatively small, and then the visual effect of the display image is effectively improved.

As shown in FIG. 2a, since the gate driving unit 06 is arranged in the peripheral area 02 at the lower end of the display area 01, the gate scanning signals output by the gate driving unit 06 is transmitted to the gate lines 03 via the first wires 07 so as to normally drive each pixel unit on the display panel to achieve image display, wherein the first wires 07 and the data lines 04 may be arranged in the same layer and isolated from each other, and the first wires 07 may also be arranged in a third metal layer, wherein the third metal layer is another metal layer except metal layers where the gate lines 03 and the data lines 04 are positioned, generally a common electrode layer assisting to be transmit common electrode voltage signals can serve as the another metal layer, and the connection of the first wires 07 in the specific pixel structure is as shown in FIG. 2c, wherein since the first wires 07 and the gate lines 03 are arranged in different layers, the first wires 07 are connected with the gate lines 03 through via holes.

The source driving unit 05 may be positioned in the peripheral area 02 that either end of the data lines 03 pointing to, namely as shown in FIG. 2b, the source driving unit 05 may be arranged in the peripheral area 02 at the left end of the display area 01; and the source driving unit 05 may also be arranged in the peripheral area 02 at the right end of the display area 01, which is unlimited herein. In such cases, as shown in FIG. 2b, the display area 01 may further comprise second wires 08 in the directions the same as the extending directions of the gate lines 03 and in one-to-one correspondence with the data lines 04, the first wires 08 connecting the corresponding data lines 04 to the source driving unit 05.

Specifically, the source driving unit 05 arranged as shown in FIG. 2b and the gate driving unit 06 are arranged in the peripheral area 02 at the left end and the right end of the display area 01 respectively, wherein the gate driving unit 06 inputs the gate scanning signals to the gate lines 03 in the display area 01, and the source driving unit 05 inputs the data signals to the data lines 04 in the display area 01 via the second wires 08, and thus the display panel is controlled to achieve normal image display; and meanwhile, since the source driving unit 05 and the gate driving unit 06 are arranged in the peripheral area 02 at the left end and the right end of the display area 01 respectively, the narrow-bezel design of the frames on the upper side and the lower side of the display panel can be achieved, so that when a plurality of display panels are longitudinally connected to achieve multi-screen display, the non-image-display area at the connecting position of adjacent display panels is relatively small, and then the visual effect of the display image is effectively improved

As shown in FIG. 2b, since the source driving unit 05 is arranged in the peripheral area 02 at the left end of the display area 01, the data signals output by the source driving unit 05 is transmitted to the data lines 04 via the second wires 08 so as to normally drive each pixel unit on the display panel to achieve image display, wherein the second wires 08 and the gate lines 03 may be arranged in the same layer and isolated from each other, and the second wires 08 may also be arranged in a third metal layer, wherein the third metal layer is another metal layer except metal layers where the gate lines 03 and the data lines 04 are positioned, generally a common electrode layer assisting to transmit common electrode voltage signals can serve as the another metal layer, and since the second wires 08 and the data lines 04 are arranged in different layers, the second wires 08 are connected with the data lines 04 through via holes.

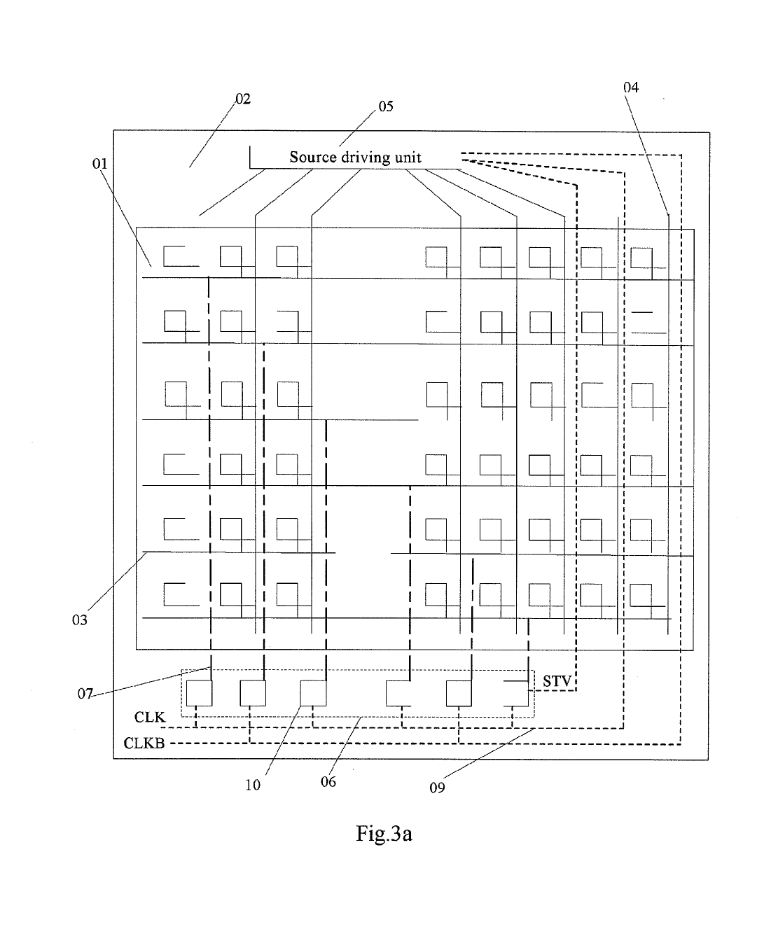

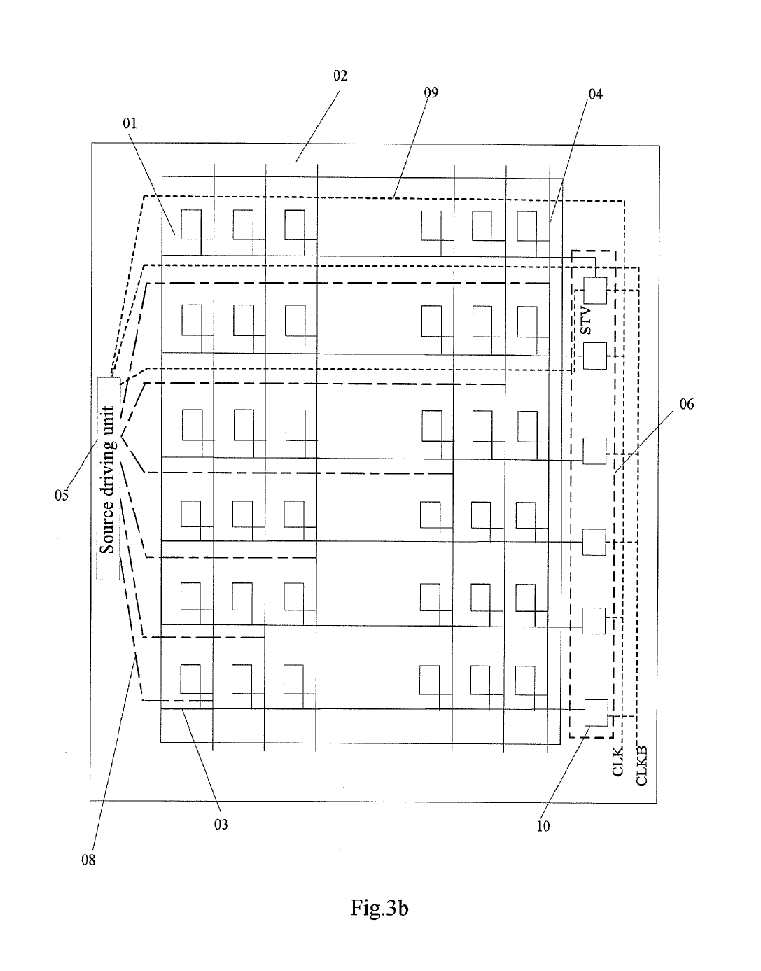

The function of the gate driving unit 06 can be achieved through a gate driving chip, and can also be achieved in the manner of a gate integrated drive circuit as shown in FIG. 3a and FIG. 3b, which is unlimited herein. Normal output of the gate scanning signals for the gate driving unit 06 can be achieved by adopting both manners, and the display panel is driven to achieve the function of image display.

As shown in FIG. 3a and FIG. 3b, when the gate driving unit 06 is the gate integrated drive circuit, the gate integrated drive circuit is provided with various signal input ends, and the source driving unit 05 is provided with various output ends; the display panel in the display area 01 may further comprise a third wires 09 which connect the signal output ends of the source driving unit 05 with the signal input ends of the gate integrated drive circuit in one-to-one correspondence manner. Generally, the gate integrated drive circuit comprises a plurality of shift register units 10. The gate integrated drive circuit achieves the function thereof under the control of various control signals such as clock signals, reference voltage signals VDD and VSS. FIG. 3a and FIG. 3b illustrate only three third wires 09 as clock signal transmission lines and a frame start signal transmission line, which are a clock signal line CLK, a clock signal line CLKB and a frame start signal line STV, wherein as shown in FIG. 3a, every two shift register units 10 are alternately connected with the clock signal lines CLK and CLKB, and the other signal line connected with the shift register unit 10 on the rightmost end is the frame start signal line STV. The gate integrated drive circuit may further comprise input ends of the control signals such as reference voltage signals VDD and VSS, which is unlimited herein. Thus, by connecting the signal output ends of the source driving unit 05 with the signal input ends of the gate integrated drive circuit in the one-to-one correspondence manner via the third wires 09, the control signals such as the clock signals CLK and CLKB and the reference voltage signals VDD and VSS output by each signal output end in the source driving unit 05 can be input to each signal input end of the gate integrated drive circuit correspondingly for controlling the gate driving circuit to normally output the gate scanning signals, in turn, drive the display panel to achieve normal image display.

The gate integrated drive circuit can be positioned in the peripheral area 02 that either end of the data lines 04 pointing to, namely as shown in FIG. 3a, the gate integrated drive circuit is arranged in the peripheral area 02 at the lower end of the display area 01; and the gate integrated drive circuit can also be arranged in the peripheral area 02 at the upper end of the display area 01, which is unlimited herein. As shown in FIG. 3a, the gate integrated drive circuit is arranged in the peripheral area 02 at the lower end of the display area 01, and the signal output ends of the source driving unit 05 are connected with the signal input ends of the gate integrated drive circuit in one-to-one correspondence manner via the third wires 09, wherein the third wires 09 and the data lines 04 are arranged in the same layer and isolated from each other, or the third wires 09 are arranged in a third metal layer, and the third metal layer is another metal layer except the layers where the data lines 04 and the gate lines 03 are positioned.

As shown in FIG. 3b, the gate integrated drive circuit is positioned in the peripheral area 02 that either end of the gate lines 03 pointing to, namely the gate integrated drive circuit is positioned in the peripheral area 02 at the right end of the display area 01, and the gate integrated drive circuit may also be arranged in the peripheral area 02 at the left end of the display area 01, which is unlimited herein. As shown in FIG. 3b, the gate integrated drive circuit is arranged in the peripheral area 02 at the right end of the display area 01, and the signal output ends of the source driving unit 05 are connected with the signal input ends of the gate integrated drive circuit in one-to-one correspondence manner via the third wires 09, wherein the third wires 09 and the gate lines are arranged in the same layer and isolated from each other, or the third wires 09 are arranged in the third metal layer, and the third metal layer is another metal layer except the layers where the data lines 04 and the gate lines 03 are positioned.

In view of the same inventive concept, embodiments of the present disclosure provide a display device, comprising the display panel provided by above embodiment of the present disclosure. The display device can be products or components with display function such as mobile phones, tablet computers, televisions, display devices, notebook computers, digital photo frames and navigators. The specific implementation of the display device can refer to the embodiment of the display panel, which will not be repeated here.

Embodiments of the present disclosure provide a display panel and a display device. In the display panel, the source driving unit and the gate driving unit are arranged in the peripheral area on two opposite sides of the display area respectively, namely when the source driving unit and the gate driving unit are longitudinally arranged in the peripheral area at the upper end and the lower end of the display area respectively, since the source driving unit and the gate driving unit are not arranged at the left end and the right end of the peripheral area of the display panel, narrow-bezel design on the left side and the right side of the display panel can be achieved. Thus, when a plurality of display panels are transversely connected to achieve multi-screen display, the non-image-display area at the connecting position of adjacent display panels becomes relatively small. Likewise, when the source driving unit and the gate driving unit are transversely arranged in the peripheral area at the left end and the right end of the display area respectively, since the source driving unit and the gate driving unit are not arranged at the upper end and the lower end of the peripheral area of the display panel, narrow-bezel design on the upper side and the lower side of the display panel can be achieved. Thus, when a plurality of display panels are longitudinally connected to achieve multi-screen display, the non-image-display area at the connecting position of adjacent display panels becomes relatively small. Therefore, compared with the mode that a plurality of display panels are connected to achieve multi-screen display in the prior art, the narrow-bezel design on the left side and the right side of or the upper side and the lower side of the display panel provided by the embodiment of the present disclosure can be achieved, so that when transverse or longitudinal multi-screen display is achieved, the non-image-display area at the connecting position of adjacent display panels is relatively small, thereby the visual effect of the display image is effectively improved.

Obviously, various modifications and variations can be made by any person skilled in the art under the condition of without departing from the spirit and the scope of the present invention. Thus, the present invention also has the intention of including these modifications and transformations if these modifications and transformations of the present invention belong to claims of the present invention and scopes in equivalent technologies of the present invention.

1-10. (canceled)

11. A display panel comprising:
a display area comprising:
a plurality of gate lines extending along a first direction; and
a plurality of data lines extending along a second direction; and
a peripheral area surrounding the display area, comprising:
a source driving unit for supplying data signals for each data line; and
a gate driving unit for supplying gate scanning signals for each gate line;
wherein the source driving unit is arranged in the peripheral area on a side of the display area; and
wherein the gate driving unit is arranged in the peripheral area on an opposite side of the display area.

12. The display panel according to claim 11, wherein:
the gate driving unit is positioned in the peripheral area adjacent an end of the data lines; the display area further comprises a plurality of first wires extending along the second direction in one-to-one correspondence with the plurality of gate lines; and
the first wires connect the corresponding gate lines to the gate driving unit.

13. The display panel according to claim 12, wherein:
the first wires and the data lines are isolated from each other; and
the first wires are arranged in a layer selected from the group consisting of the same layer as the data lines and a third layer.

14. The display panel according to claim 11, wherein:
the source driving unit is positioned in the peripheral area adjacent an end of the gate lines;
the display area further comprises a plurality of second wires extending along the first direction in one-to-one correspondence with the plurality of data lines; and
the second wires connect the corresponding data lines to the source driving unit.

15. The display panel according to claim 14, wherein:
the second wires and the gate lines are isolated from each other; and
the second wires are arranged in a layer selected from the group consisting of the same layer as the gate lines and a third layer.

16. The display panel according to claim 11, wherein the gate driving unit is selected from the group consisting of a gate driving chip and a gate integrated drive circuit.

17. The display panel according to claim 12, wherein the gate driving unit is selected from the group consisting of a gate driving chip and a gate integrated drive circuit.

18. The display panel according to claim 13, wherein the gate driving unit is selected from the group consisting of a gate driving chip and a gate integrated drive circuit.

19. The display panel according to claim 14, wherein the gate driving unit is selected from the group consisting of a gate driving chip and a gate integrated drive circuit.

20. The display panel according to claim 15, wherein the gate driving unit is selected from the group consisting of a gate driving chip and a gate integrated drive circuit.

21. The display panel according to claim 16, wherein:
the gate driving unit is a gate integrated drive circuit;
the gate integrated drive circuit includes a plurality of signal inputs;
the source driving unit includes a plurality signal outputs; and
a plurality of third wires connect the signal inputs to the signal outputs in a one-to-one correspondence.

22. The display panel according to claim 21, wherein:
the gate integrated drive circuit is positioned in the peripheral area adjacent an end of the data lines;
the third wires and the data lines are isolated from each other; and
the third wires are arranged in a layer selected from the group consisting of the same layer as the data lines and a third layer.

23. The display panel according to claim 21, wherein:
the gate integrated drive circuit is positioned in the peripheral area adjacent an end of the gate lines;
the third wires and the data lines are isolated from each other; and
the third wires are arranged in a layer selected from the group consisting of the same layer as the data lines and a third layer.

24. A display device comprising:
a frame; and
a display panel comprising:
a display area comprising:
a plurality of gate lines extending along a first direction; and
a plurality of data lines extending along a second direction; and
a peripheral area surrounding the display area, comprising:
a source driving unit for supplying data signals for each data line; and
a gate driving unit for supplying gate scanning signals for each gate line;
wherein the source driving unit is arranged in the peripheral area on a side of the display area; and
wherein the gate driving unit is arranged in the peripheral area on an opposite side of the display area.

25. The display device according to claim 23, wherein:
the gate driving unit is positioned in the peripheral area adjacent an end of the data lines; the display area further comprises a plurality of first wires extending along the second direction in one-to-one correspondence with the plurality of gate lines; and
the first wires connect the corresponding gate lines to the gate driving unit.

26. The display device according to claim 24, wherein:
the first wires and the data lines are isolated from each other; and
the first wires are arranged in a layer selected from the group consisting of the same layer as the data lines and a third layer.

27. The display device according to claim 23, wherein:
the source driving unit is positioned in the peripheral area adjacent an end of the gate lines;
the display area further comprises a plurality of second wires extending along the first direction in one-to-one correspondence with the plurality of data lines; and
the second wires connect the corresponding data lines to the source driving unit.

28. The display device according to claim 26, wherein:
the second wires and the gate lines are isolated from each other; and
the second wires are arranged in a layer selected from the group consisting of the same layer as the gate lines and a third layer.
